(19) United States
(12) Patent Application Publication
(10) Pub. No.: US 2002/0182033 A1
(43) Pub. Date: Dec. 5, 2002

(54) Method and apparatus for creation of a book spine

(76) Inventor: Ilan Weiss, Kfar-Saba (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 10/124,765

(22) Filed: Apr. 18, 2002

Related U.S. Application Data
(60) Provisional application No. 60/284,511, filed on Apr. 19, 2001.

(51) Int. Cl. B42C 11/00; B42C 1/00

(52) U.S. Cl. 412/1

(57) ABSTRACT

In some embodiments, a method for binding a book is provided. The method comprises mechanically stacking sheets of paper, each having notches in one edge, into an aligned book block having a spine. The notches are generally all facing the same direction and staggered in relation to each other. The method may further comprises positioning a cover such that an inner central portion of the cover abuts the spine and causing the central portion and the spine to adhere to each other.

### CROSS REFERENCE TO RELATED APPLICATIONS

The present application claims priority from U.S. provisional application Serial No. 60/284,511, filed Apr. 19, 2001.

### BACKGROUND OF THE INVENTION

Printed pages may be bound into a book using various methods. FIGS. 1A-1D illustrate an example of such a conventional method for bookbinding. Via known in the art printing methods, a roll of paper 2 having a width W is printed on, then cut (FIG. 1B) and aligned to form a stack of paper 4 having a spine 6 (FIG. 1C). Spine 6 may then be ground to expose paper threads. Next, a series of parallel grooves 8 may be cut into the spine, along the thickness of the spine. It is known in the art that grooves and paper threads may improve adhesion. An adhesive is then applied into grooves 8, contacting, and adhering to groove walls 7. A book cover (not shown) is then applied to the adhesive, and pressure is applied to both the stack and the cover, binding them together to create a book.

Since grooves 8 are aligned, the adhesive applied to grooves 8 adheres mainly to walls 7. The subsequent adhesion may be weaker than desired. Furthermore, the cutting of grooves 8 creates a cutout portion that may fall into the machine, creating dirt and dust. The leftover dust may interfere with the adhesive process. It is also noted that the stages of groove cutting and grinding are very time consuming and decrease the production rate and through put of book producing.

It is therefore desirable to create an improved or different method for bookbinding.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A-1D illustrate a conventional bookbinding method;

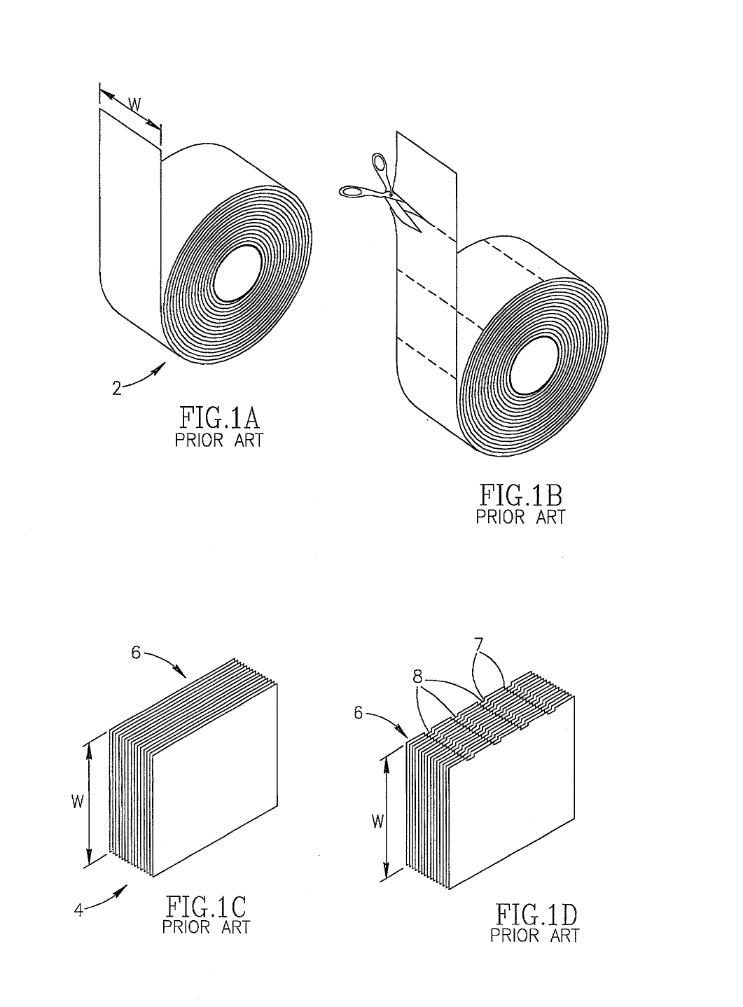

FIGS. 2A-2B are schematic representations of a roll of paper according to some embodiments of the present invention;

FIGS. 2C-2D illustrate a bookbinding method according to some embodiments of the present invention;

FIGS. 3A-3I are schematic representations of rolls of paper according to some embodiments of the present invention; and

FIG. 4 is a flow chart diagram illustrating a method for automatic bookbinding according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PREFERRED EMBODIMENT

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Some embodiments of the present invention are directed to a method for automatic bookbinding. The method utilizes a roll of paper or sheets of paper with pre-produced notches to produce a book spine with paper that has pre-produced notches. The pre-notched roll of paper or pre-notched sheets of paper may be printed thereon. Once the printed sheets of paper are stacked into a book block, the notches are randomly spaced along the spine, allowing for greater adhesion.

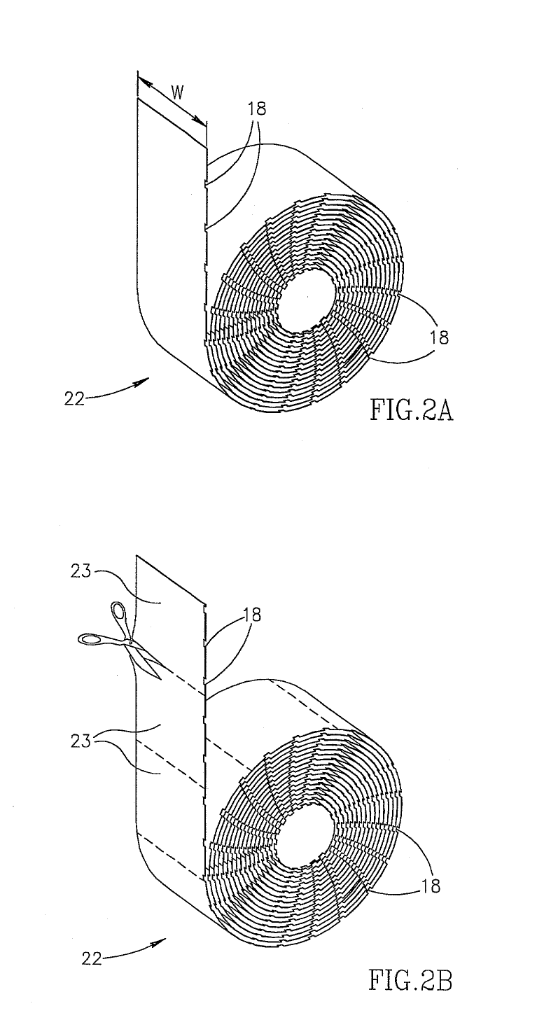

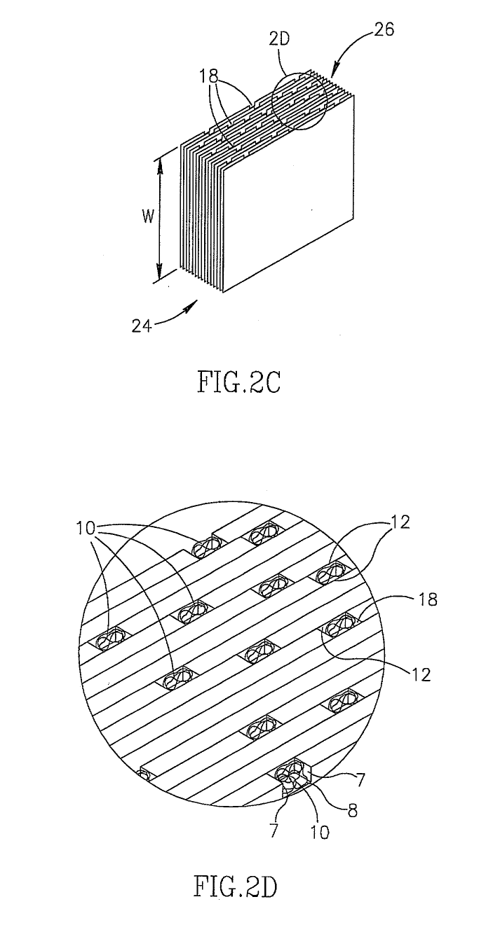

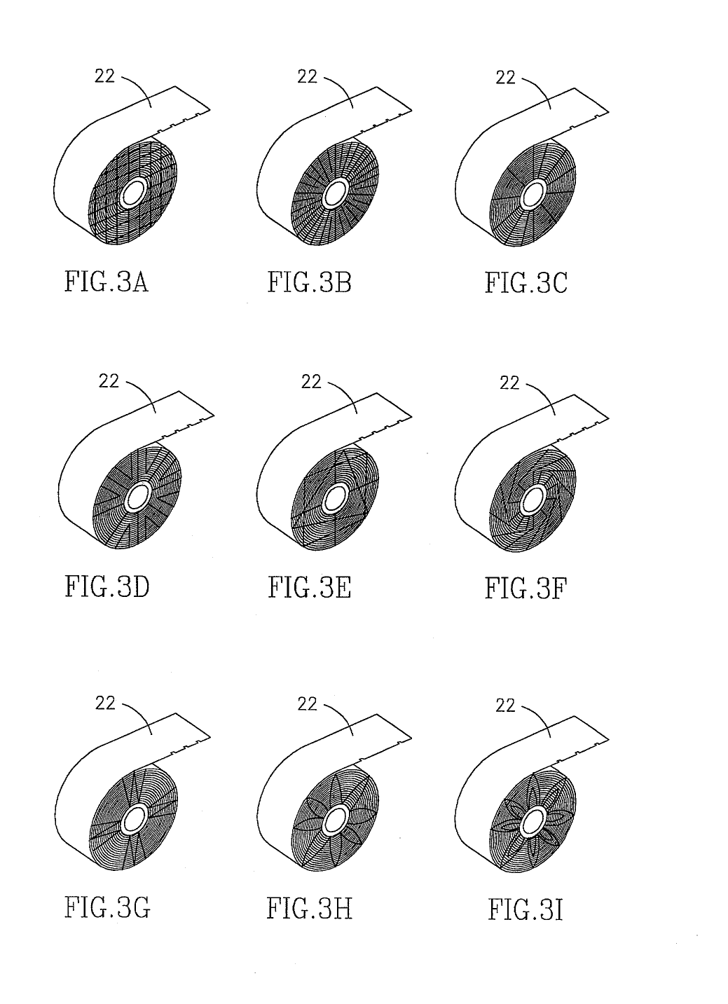

Reference is now made to FIGS. 2A-2B, which are schematic representations of a roll of paper according to some embodiments of the present invention. As can be noted in FIG. 2A, a roll of paper 22 may be grooved on one of its circular side-surfaces to produce notches 18. The depth and geometrical configuration of the notches may vary depending on specific requirements according to the application. FIGS. 3A-3I illustrate alternative embodiments of pre-notched, optionally pre-ground, roll of paper 22. Generally, the width of roll 22 may be similar to the width of a book that is to be made of the roll.

Roll 22 may be mounted on a printing machine (not shown) to be printed thereon. The printed roll of paper may be mechanically cut to produce printed sheets 23 having the size of the requested pages of a book. Alternatively roll 22 may be first cut into sheets of paper 23 to be printed thereon.

Each sheet of paper 23 is pre-notched with multiple notches 18 along one longitudinal edge. Roll 22 may be cut such that when sheets 23 are aligned into a book block having a spine 26, the notches are staggered with respect to each other. In some embodiments of the present invention, roll of paper 22 may also be pre-ground before grooving. In other embodiments, the grinding stage may replace the grooving stage. The cutting stage as illustrated in FIG. 2B, and the aligning stage (not shown), are both known in the art methods and will not be described further.

When a pre-notched roll of paper, such as roll 22, or a pre-notched stack of paper is provided to a printing machine, the time-consuming groove-cutting stage is not required in the bookbinding process. Therefore, the process may be faster and also an improved adhesion may be achieved due to the elimination of the dirt and mess stemming from the groove-cutting stage.

It is noted that although FIGS. 2A-2B show a roll of paper, the method described hereinabove may be initiated with a stack of paper. In these embodiments, a plurality of un-printed sheets of paper may be pre-notched and then aligned into a stack such that generally the notches are located on the same side of the stack of papers and not aligned with each other.

It is additionally noted that the number and size of grooves 18 as shown in FIGS. 2A-2D are representative only, and may vary from application to application and still comply with the basis of the method as described. It is further noted that the actual bookbinding procedure may be more complex than that described; however, the described method comprise some of the basic processes used in bookbinding.

FIG. 2C illustrates the pre-notched, optionally printed, sheets of paper 23 accumulated into a stack 24. As seen in the illustration, spine 26 is created from the pre-notched edges of papers 23. Additionally noted, notches 18 are staggered and not aligned into grooves as can be better seen in FIG. 2D, a blown up illustration of a portion of spine 26.

An adhesive 10 may be applied directly to spine 26. Alternatively, adhesive 10 may be applied to the inner surface of central portion 7 of cover 3, which is positioned such that the adhesive is applied also to the spine.

Once an adhesive 10 is applied to spine 26, either directly or indirectly, the staggering of notches 18 allows for a widespread distribution of the adhesive 10 along spine 26. Since notches 18 are not aligned, adhesive 10 is free to flow and adhere to the pages adjacent to the page of notch 18. Adhesive 10 thus contacts not only walls 7, but also contacts areas 12 of sheets of paper in front of and behind notch 18, respectively.

As seen, walls 7 are along the width of paper 23, and produce a thin contact area that is only an edge of the paper 23. Areas 12 are along the front (or back) of paper 23, producing much larger contact areas than walls 7. Thus, the present adhesion method, which contacts walls 7 and 12 may be stronger than existing methods that involves contact only with walls 7.

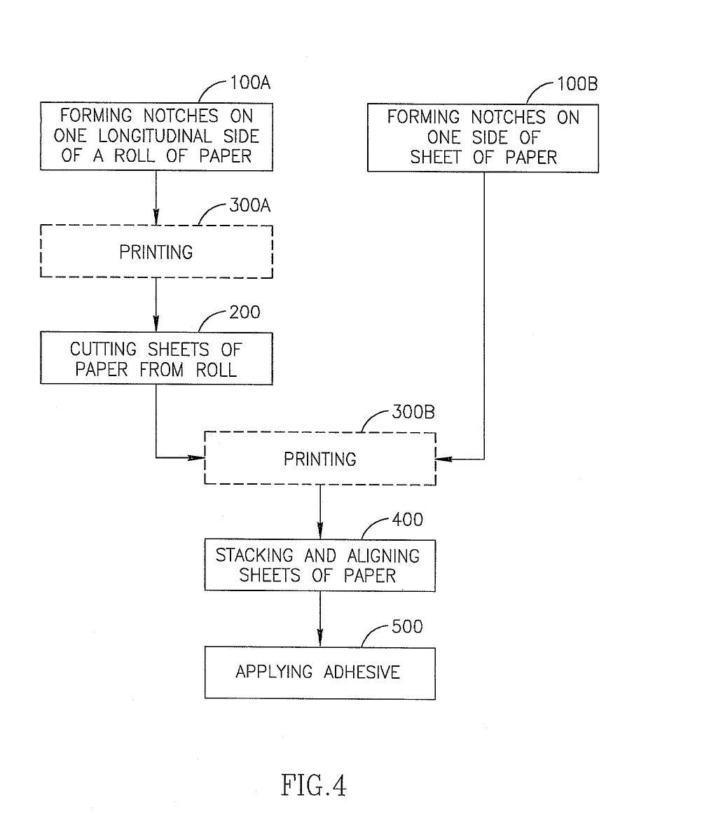

Reference is now made to FIG. 4, which is a flow chart diagram illustrating a method for automatic bookbinding according to some embodiments of the present invention. First, notches may be formed on one longitudinal edge of paper (block 100). The paper may be either in the form of a roll of paper or a plurality of sheets of paper. Then, if a roll of paper is used, the roll may be cut into sheets of paper (block 200). Optionally, the roll of paper or sheets of paper are printed thereon (blocks 300A, 300B). The sheets of papers are then stacked and aligned so that the notches are generally all facing the same direction and are generally staggered to each other (block 400). Then, an adhesive may be applied either to the spine or to an inner surface of the central portion of a cover for a book causing the cover and the spine to adhere (block 500).

By having the cutting and/or grinding phase done at the paper manufacturer's site, using a pre-notched roll of paper or a pre-notched stack of paper according to some embodiments of the present invention is a practical option for many bookbinding processes, such as digital on-demand book making processes. As an example, a pre-notched paper, in either rolls or package form, may be especially useful for book production in small office machines where grooving or grinding are not pragmatic options. Furthermore, when used in digital book printing devices such as that described in U.S. application Ser. No. 09/495,942, A PAPERBACK FINISHING MACHINE, a pre-notched paper may provide space and maintenance savings, timesaving, and environmental cleanliness. When using pre-notched paper, the entire bookbinding process may be simplified and streamlined.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
mechanically stacking sheets of paper, each having notches in one edge, into an aligned book block having a spine so that said notches are generally all facing the same direction and staggered in relation to each other.

2. The method of claim 1 further comprising:
mechanically positioning a cover such that an inner central portion of said cover abuts said spine; and
causing said central portion and said spine to adhere to each other.

3. The method of claim 1 further comprising:
printing on one or more of said sheets of paper before stacking.

4. The method of claim 1 further comprising:
mechanically cutting a roll of paper having notches along one of its longitudinal edges into said sheets of paper.

5. The method of claim 4 further comprising:
printing on said roll of paper before cutting.

6. A method in preparation for automatic bookbinding, the method comprising:
grooving a pattern onto a side surface of a roll of paper for use in a printing machine to produce a plurality of notches into a longitudinal edge of said roll of paper.

7. The method of claim 6, further comprising:
mechanically grinding said side surface.

8. A method in preparation for automatic bookbinding, the method comprising:
mechanically grinding a side surface of a roll of paper for use in a printing machine.

9. A method for producing a sheet of paper for automatic bookbinding, the method comprising:
mechanically cutting a plurality of notches into a longitudinal edge of said sheet.

10. A roll of for use in an automatic bookbinding machine, said roll of paper including a plurality of notches cut into a longitudinal edge of said roll of paper.

11. The roll of paper of claim 10, wherein said longitudinal edge is a ground edge.

12. A stack of papers for use in an automatic bookbinding machine, wherein each of said papers has a plurality of notches cut into a longitudinal edge of said paper, and generally all of said notches are located on the same side of said stack of papers and not-aligned with each other.
